(19) United States
(12) Patent Application Publication
(10) Pub. No.: US 2012/0300886 A1
(43) Pub. Date: Nov. 29, 2012

(54) METHODS FOR EARLY TERMINATION OF RECEPTION OF A BIT STREAM

(76) Inventors: Cristina Seibert, Mountain View, CA (US); Edwin Shearer, Pleasanton, CA (US)

(21) Appl. No.: 13/482,683

(22) Filed: May 29, 2012

Related U.S. Application Data
(60) Provisional application No. 61/491,068, filed on May 27, 2011.

(51) Int. Cl. H04L 27/00; H04L 27/06

(52) U.S. Cl. 375/341; 375/316

(57) ABSTRACT

A method of receiving a bitstream. The method includes receiving a sequence of bits of a bitstream, assigning a confidence level to each bit in the sequence of bits, maintaining a running confidence level of the sequence of bits as the bits are received, comparing the running confidence level to a threshold, terminating reception of the bitstream when the running confidence level is below the threshold, and requesting retransmission of the bitstream. Wherein the reception of the bitstream and the requesting of retransmission of the bitstream occurs prior to the entire bitstream being received.

### RELATED APPLICATIONS

This application claims the benefit of co-pending U.S. Provisional Patent Application No. 61/491,068, filed May 27, 2011, the content of which is hereby included by reference.

### BACKGROUND

The invention relates to error detection in wireless communications. More precisely, the invention relates to terminating reception of a wireless communication determined to include uncorrected errors.

Various techniques are employed for determining the accuracy of a received communication. For example, early techniques included binary check sums and cyclic redundancy codes. More recently, more sophisticated techniques have been employed, especially in wireless communication environments, which also include error correcting ability. The most common technique employed in wireless communication is convolution coding with Viterbi demodulation. This technique can result in very low bit error rates (BER).

### SUMMARY

In one embodiment, the invention provides a method of terminating reception of a bit stream. The method includes receiving a signal including a bit stream, the signal having a signal strength, developing a confidence level for the bit stream based on the signal strength for each bit of the bit stream when the bit was received, and terminating reception of the bit stream when the confidence level is below a threshold. In some embodiments, the confidence level is a running mean. In some embodiments, the method further includes adjusting the confidence level based on the ability to correct a bit. In some embodiments, the reception is terminated while receiving a packet header.

In another embodiment, the invention provides a method of receiving a bitstream. The method includes receiving a sequence of bits of a bitstream, assigning a confidence level to each bit in the sequence of bits, maintaining a running confidence level of the sequence of bits as the bits are received, comparing the running confidence level to a threshold, terminating reception of the bitstream when the running confidence level is below the threshold, and requesting retransmission of the bitstream. Wherein the reception of the bitstream and the requesting of retransmission of the bitstream occurs prior to the entire bitstream being received.

In another embodiment, the invention provides a method of receiving a bitstream. The method includes receiving a sequence of bits of a bitstream, assigning a confidence level to each bit in the sequence of bits, adjusting a bitstream confidence level based on the assigned confidence level of each bit, determining that the bitstream confidence level is below an acceptable predetermined level, terminating reception of the bitstream when the bitstream confidence level is below the acceptable predetermined level, and requesting retransmission of the bitstream. Wherein the reception of the bitstream and the requesting of retransmission of the bitstream occurs prior to the entire bitstream being received.

Other aspects of the invention will become apparent by consideration of the detailed description and accompanying drawings.

### BRIEF DESCRIPTION OF THE DRAWINGS

FIG. 1 is a schematic diagram of a wireless communication system.

FIGS. 2A-2D are a set of charts of a simulation of a bitstream transmission showing bit errors estimated by the invention versus bit errors actually occurring.

FIG. 3 is a diagram showing a relationship of a bit stream to a signal strength.

FIG. 4 is a process for terminating a reception of a bit stream when a developed confidence level is below a threshold.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

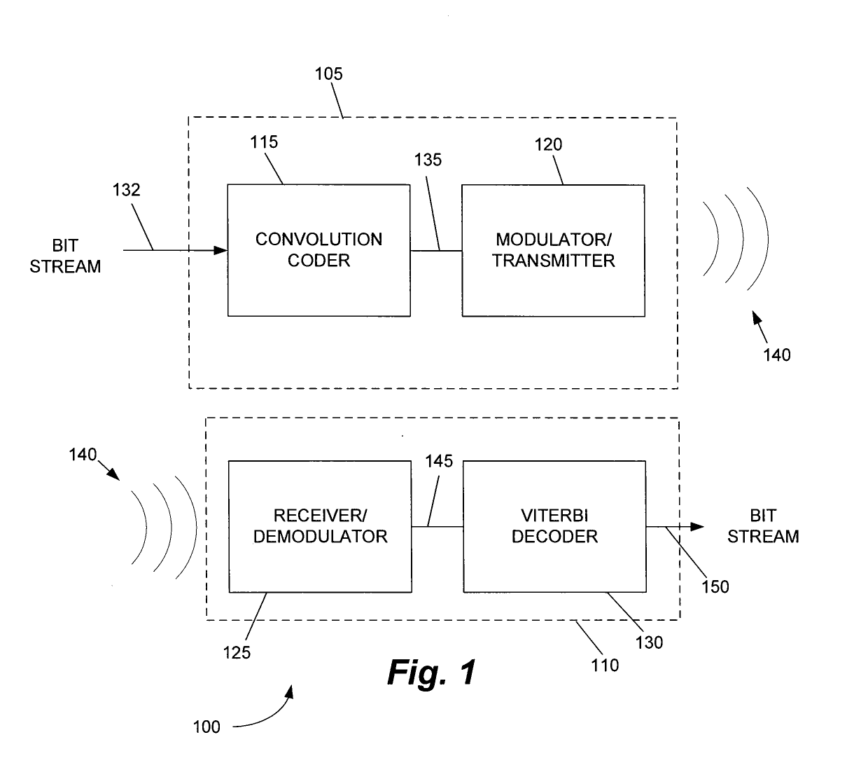

The use of wireless communication has become ubiquitous. Common uses for wireless communication include WiFi, cellular telephones, automated utility meter reading, etc. FIG. 1 shows a construction of a common wireless communication system 100. The system 100 includes a transmission module 105 and a remote reception module 110. The transmission module 105 includes a convolution encoder 115 and a modulator/transmitter 120. The remote reception module 110 includes a receiver/demodulator 125, and Viterbi decoder 130. The convolution encoder 115 receives a bit stream 132 to be transmitted to the remote reception module 110. The convolution encoder 115, as is known in the industry, uses a convolution algorithm to create a bit stream 135 that is capable of having errors in the bit stream 135 corrected by a decoder. In other constructions, the bit stream is not encoded. In such constructions, the convolution encoder 115 and the Viterbi decoder 130 would not be included.

The correctable bit stream 135 is provided to the modulator/transmitter 120. The modulator/transmitter 120 modulates the correctable bit stream 135 and transmits the modulated signal 140. The receiver/demodulator 125 receives the signal 140 and demodulates the signal 140. The receiver/demodulator 125 outputs a received bit stream 145. In theory, the received bit stream 145 should be the same as the correctable bit stream 135. However, because of noise, signal strength, etc. the signal 140 may become corrupted between the transmission module 105 and the remote reception module 110. Accordingly, there may exist differences between the correctable bit stream 135 and the received bit stream 145.

The received bit stream 145 is fed into the Viterbi decoder 130. The Viterbi decoder 130 decodes the received bit stream 145, and attempts to correct any bit errors in the received bit stream 145. The Viterbi decoder 130 then outputs a final bit stream 150. If all of the errors, if any, in the received bit stream 145 are able to be corrected, the final bit stream 150 matches the bit stream 132 originally received by the transmission module 105.

However, should there be bit errors that are not able to be corrected; the remote reception module 110 must request that the transmission module 105 resend the entire transmission. The invention uses confidence levels to determine when a received bit stream 145 has a BER that exceeds a threshold. When the BER is determined to exceed the threshold, the transmission module 105 terminates reception of the signal 140 reducing power consumption and “deaf time.” There is a correlation between BER and signal characteristics, such as the signal strength or the soft bit values estimated by a forward error correction (FEC) decoder. Confidence levels are determined based on a criteria (e.g., the signal strength) of signal 140 received by the remote reception module 110. A high confidence level is assigned to bits that are received when the criteria is met (e.g., signal strength is high), and lower confidence levels are assigned to bits that are received when the criteria is not met. In addition, bits that require correction can be used to reduce the confidence level. Thus, a bit that does not require correction and is received during a high signal strength period is assigned the highest confidence level. A bit that requires correction and was received when signal strength was very low is assigned the lowest confidence level. The confidence level is adjusted between the highest and lowest confidence level for different signal strengths and different quantities of corrected bits. In some embodiments, the Viterbi decoder 130 produces the confidence level as is known in the industry.

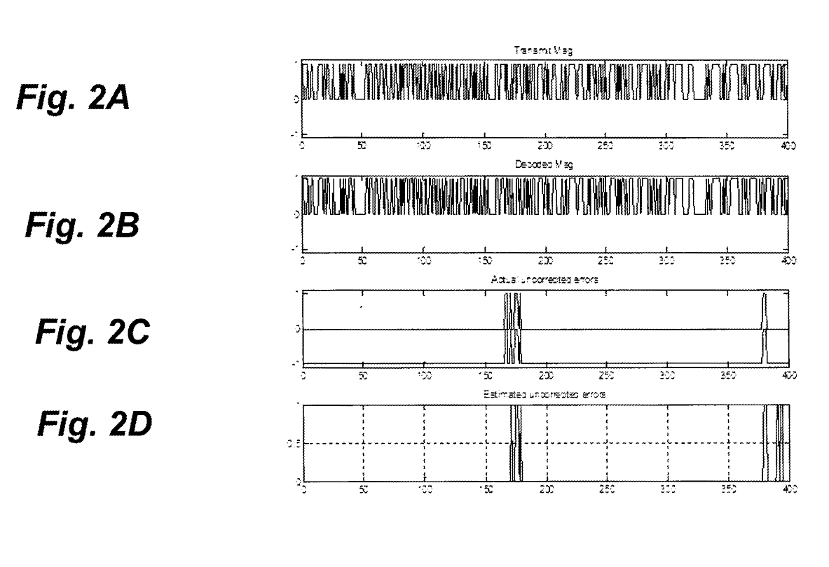

In some embodiments, the confidence level is used to estimate whether a bit error has occurred or not. An estimated BER is then calculated, and the transmission of the bitstream is terminated when the estimated BER exceeds a threshold. FIGS. 2A-2D are a set of charts of a simulation of a bitstream transmission. FIG. 2A is the transmitted bitstream. FIG. 2B is the received bitstream. FIG. 2C shows the actual bit errors in the received bitstream. FIG. 2D shows the bit errors estimated by the invention based on filtered soft bit outputs of a Viterbi decoder. As shown in the charts, the invention provides an accurate indication of the errors occurring in the received bitstream. Based on the estimated BER, the bitstream transmission can be terminated when the BER exceeds a predetermined threshold. The threshold can be determined empirically or through testing.

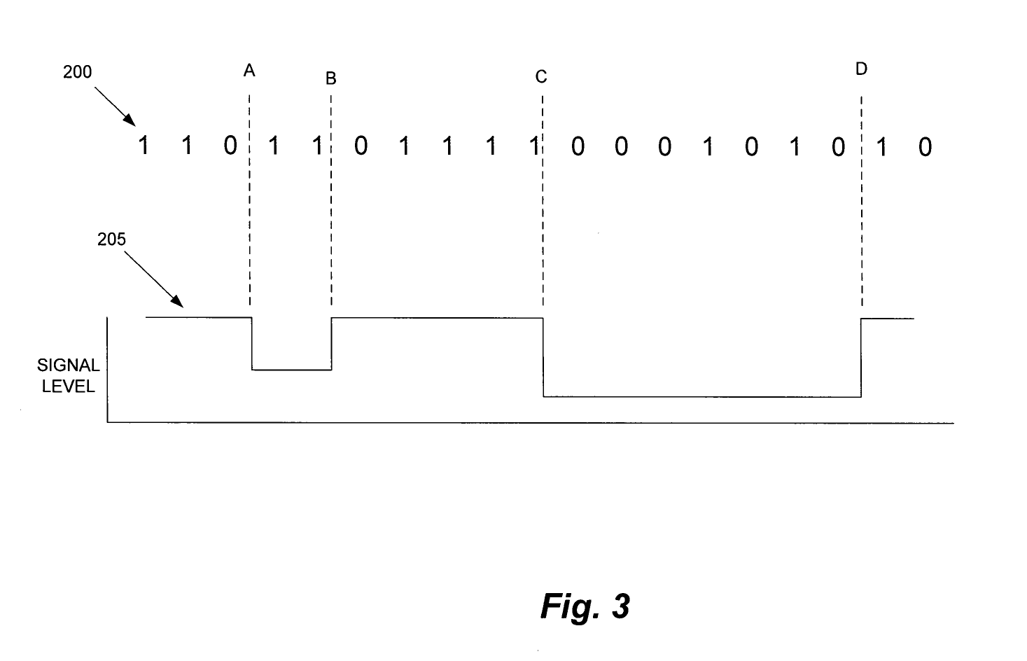

FIG. 3 shows an exemplary bit stream 200 and a signal strength indication 205 for when each bit is received. Signal strength is high for the first three bits, prior to point A. From point A to point B, the next two bits, the signal strength is reduced (but not to the lowest level). From point B to point C, signal strength is again at its highest level. Then from point C to point D, signal strength is very low. Bit stream 200 can be either the received bit stream 145 or the final bit stream 150.

Using a confidence scale of one to ten, confidence, based exclusively on signal strength is determined as shown in table 1 below.

In one embodiment, a running mean confidence level is determined. Should the mean confidence level fall below a predetermined threshold, the reception is terminated. Table 2 below shows the mean confidence level after each bit is received.

TABLE 1

| Period | Confidence Level | Number of Bits |
|---|---|---|
| To A | 10 | 3 |
| A to B | 5 | 2 |
| B to C | 10 | 5 |
| C to D | 1 | 7 |

Thus, if the mean confidence threshold was 8.5, the reception would be terminated after bit 5, and if the mean confidence threshold was 8.0, the reception would be terminated after bit 12. The confidence threshold is set based on the importance of the data. For example, a digital television (e.g., 8.0) signal may have a lower confidence threshold than a mission critical communication (e.g., 9.5)

In another embodiment, the need to correct bit errors is used to adjust the confidence level. For example, if bits four and five did not require correction, the confidence level of five, based on the signal strength, is raised. The amount that the confidence level is raised can be a fixed amount or can be a variable amount. The adjustment to confidence level can be made to the bits that are received that do not require correction, or the confidence level for the particular signal strength can be increased. That is, the system can determine, because bit errors are not occurring, that a signal strength of 50% is strong enough to result in a minimal BER. Thus, the confidence level can increase, over time, to nine, for example, for a 50% signal strength.

In other embodiments, the system uses the number of bits that can be corrected, the ratio of bits that can be corrected versus the number of bits that cannot be corrected, and/or the temporal relationship of bits that can not be corrected to other bits that can not be corrected to adjust a running confidence level or to generate a specific confidence level (e.g., when ten bits in a row need correcting and cannot be corrected, a low confidence level is determined and reception terminated).

TABLE 2

| Bit | Total Confidence # | Mean Confidence Level |
|---|---|---|
| 1 | 10 | 10 |
| 2 | 20 | 10 |
| 3 | 30 | 10 |
| 4 | 35 | 8.75 |
| 5 | 40 | 8 |
| 6 | 50 | 8.33 |
| 7 | 60 | 8.57 |
| 8 | 70 | 8.75 |
| 9 | 80 | 8.89 |
| 10 | 90 | 9 |
| 11 | 91 | 8.27 |
| 12 | 92 | 7.67 |
| 13 | 93 | 7.15 |
| 14 | 94 | 6.71 |
| 15 | 95 | 6.33 |
| 16 | 96 | 6 |
| 17 | 97 | 5.70 |

Prior art error detection schemes generally rely upon overhead bits that are dedicated to consistency checking. These overhead bits are typically included after a packet header and/or an entire packet payload preventing termination of reception during the packet header. The invention enables termination of reception at any point of a received bit stream.

In addition, the invention allows for termination of reception of certain communication formats do not accommodate the inclusion of consistency checking bits (e.g., IEEE 802.15.4 g).

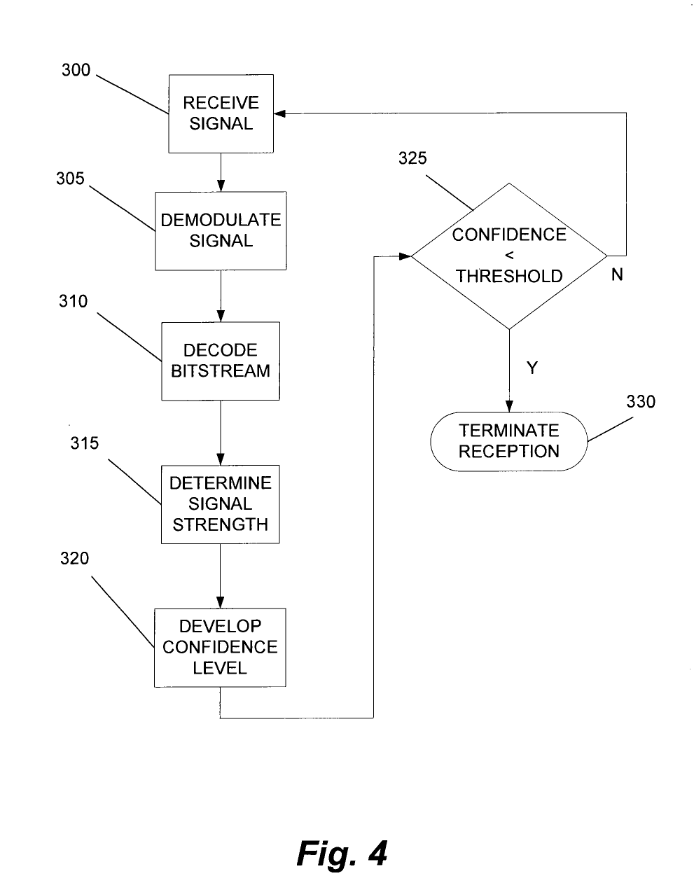

FIG. 4 shows a process for early termination of reception of a communication should uncorrectable bit errors occur. The process begins by receiving the signal 140 by the remote reception module 110 (step 300). The receiver/demodulator 125 demodulates the signal 140 into the received bit stream 145 (step 305). In the embodiment shown in FIG. 3, the final bit stream 150 is used to determine the confidence level, and the Viterbi decoder 130, decodes the received bit stream 145 (step 310). In other embodiments, the received bit stream 145 is used to determine the confidence level and step 310 is omitted (for the determination of confidence level, however, the received bit stream 145 is still decoded by the system). Next, the strength of the signal 140 at the point in time that each bit of the final bit stream 150 was received is determined (step 315). Next a confidence level is developed as described above (step 320). The confidence level is compared to a predetermined threshold (step 325), and reception is terminated (step 330) if the confidence level is less than the threshold.

What is claimed is:

1. A method of receiving a bitstream, the method comprising:
receiving a sequence of bits of a bitstream;
assigning a confidence level to each bit in the sequence of bits;
maintaining a running confidence level of the sequence of bits as the bits are received;
comparing the running confidence level to a threshold;
terminating reception of the bitstream when the running confidence level is below the threshold; and
requesting retransmission of the bitstream;
wherein the reception of the bitstream and the requesting of retransmission of the bitstream occurs prior to the entire bitstream being received.

2. The method of claim 1, wherein the confidence level for a bit is based on a signal strength.

3. The method of claim 1, further comprising determining a bit in the sequence of bits is erroneous.

4. The method of claim 3, wherein the confidence level of the erroneous bit is reduced.

5. The method of claim 4, wherein the running confidence level is reduced a lesser amount when the bit is repairable.

6. The method of claim 3, further comprising attempting to fix the erroneous bit.

7. The method of claim 6, wherein a Viterbi decoder attempts to correct the erroneous bit.

8. The method of claim 3, wherein the running confidence level is adjusted based on the number of erroneous bits in the sequence of bits.

9. The method of claim 1, wherein the running confidence level is adjusted based on a ratio of bits corrected.

10. The method of claim 1, wherein the bitstream has a format that does not accommodate consistency checking bits.

11. The method of claim 1, wherein the threshold is set based on an importance of the data in the bitstream.

12. The method of claim 1, wherein the confidence level is assigned to each bit based on an output of a Viterbi decoder.

13. A method of receiving a bitstream, the method comprising:
receiving a sequence of bits of a bitstream;
assigning a confidence level to each bit in the sequence of bits;
adjusting a bitstream confidence level based on the assigned confidence level of each bit;
determining that the bitstream confidence level is below an acceptable predetermined level;
terminating reception of the bitstream when the bitstream confidence level is below the acceptable predetermined level; and
requesting retransmission of the bitstream;
wherein the reception of the bitstream and the requesting of retransmission of the bitstream occurs prior to the entire bitstream being received.

14. The method of claim 13, further comprising determining a bit in the sequence of bits is erroneous.

15. The method of claim 14, wherein the bitstream confidence level is reduced when an erroneous bit is received.

16. The method of claim 15, wherein the bitstream confidence level is reduced a lesser amount when the bit is fixable.

17. The method of claim 15, wherein the bitstream confidence level is adjusted based on the number of erroneous bits in the sequence of bits.

18. The method of claim 13, wherein the bitstream confidence level is adjusted based on a ratio of bits corrected.

19. The method of claim 13, wherein the confidence level for a bit is based on a signal strength.

20. The method of claim 13, wherein the predetermined level is set based on an importance of the data in the bitstream.
